(19) United States
(12) Patent Application Publication
(10) Pub. No.: US 2017/0199272 A1
(43) Pub. Date: Jul. 13, 2017

(54) OPTICAL REFLECTION SENSOR AND ELECTRONIC DEVICE

(71) Applicant: SHARP KABUSHIKI KAISHA, Sakai City, Osaka (JP)

(72) Inventors: Takashi TAKAOKA, Sakai City, Osaka (JP); Norikazu OKADA, Sakai City, Osaka (JP); Toshiyuki TAKADA, Sakai City, Osaka (JP); Masaki TSUJI, Sakai City, Osaka (JP); Katsunori SATOH, Sakai City, Osaka (JP)

(73) Assignee: SHARP KABUSHIKI KAISHA, Sakai City, Osaka (JP)

(21) Appl. No.: 15/313,782

(22) PCT Filed: May 21, 2015
(86) PCT No.: PCT/JP2015/064596

§ 371 Date: Nov. 23, 2016

(30) Foreign Application Priority Data
Jul. 3, 2014 (JP) 2014-137884

(51) Int. Cl. G01S 7/486; G01C 3/08; G01S 17/10

(52) U.S. Cl. CPC G01S 7/4865; G01S 17/10; G01C 3/08

(57) ABSTRACT

An optical reflection sensor includes a light emitting element that irradiates a distance measuring target with light, a light receiving optical system that condenses reflected light from the distance measuring target, a light receiving element that receives light condensed by the light receiving optical system and outputs a photoelectric current signal corresponding to a light receiving position, and a signal processing circuit that obtains light receiving position information on the light receiving element and time-of-flight information of the light, which is a duration from when the light is emitted by the light emitting element to when the light is reflected by the distance measuring target and received by the light receiving element, on the basis of the photoelectric current signal output from the light receiving element.

### TECHNICAL FIELD

The present invention relates to a reflection sensor that detects the presence of an object or detects the distance to an object, and relates to an electronic apparatus that includes the reflection sensor.

### BACKGROUND ART

Conventionally, reflection sensors that detect the presence of an object or detect the distance to an object include those such as the following:
Japanese Unexamined Patent Application Publication No. 2013-113610 (PTL 1)
Japanese Unexamined Patent Application Publication No. 2013-210315 (PTL 2)
Japanese Unexamined Patent Application Publication No. 2012-63173 (PTL 3)
Japanese Unexamined Patent Application Publication No. 2-61510 (PTL 4)
Japanese Unexamined Patent Application Publication No. 2013-134173 (PTL 5)

In the “radiation measuring method and apparatus” disclosed in the aforementioned PTL 1, radiation from a radiation source is detected while changing the position and the orientation of a two-dimensional radiation detector having directionality, and the source location of the radiation is estimated by expressing the detection angle region of the obtained radiation in a measurement space that has been converted into voxels.

In the “optical distance measuring apparatus” disclosed in the aforementioned PTL 2, a returning light condenser optical system includes a returning light condenser lens, this returning light condenser lens includes an optical path along which a laser beam emitted by a laser beam output element and reflected by a scanning mirror travels to an irradiation point, has optical characteristics that its refractive power in the widthwise direction within a plane perpendicular to a scanning surface is greater than its refractive power in the direction of the scanning surface, and condenses received returning light from the irradiation point onto the scanning mirror. Thus, a larger amount of returning light can be obtained, and the effective range of measuring the distance can be obtained to a sufficient level.

In the “laser distance measuring apparatus” disclosed in the aforementioned PTL 3, a laser beam from a laser diode is deflected by a two-dimensional scanner that includes a mirror, and a vertex of a desired polygon on a measurement target is irradiated therewith. Then, a laser beam reflected by each vertex is received by a photodiode so as to output a signal, and the area of the aforementioned polygon is calculated with an arithmetic control unit by using an output signal from the photodiode and the operation information of the two-dimensional scanner.

In the “contactless two-dimensional shape measuring sensor” disclosed in the aforementioned PTL 4, reflected light, from a surface of an object, of a thin light ray that has been emitted by a light source, has been deflected by an optical deflector that includes a mirror, and has illuminated the object at a constant width is condensed by a light receiving lens to form an image on an image sensor. In this case, a converging lens that converges light only in a direction perpendicular to a detection line of the image sensor is disposed between the light receiving lens and the image sensor, and, of the thin light ray deflected to have a constant width, a portion of the reflected light of the thin light ray that is offset in the perpendicular direction from the center portion is also imaged on the image sensor. Thus, the distance in a two-dimensional direction can be measured with the one-dimensional image sensor.

In the “distance measuring system” disclosed in the aforementioned PTL 5, a photoelectron corresponding to the quantity of incident light is cumulatively accumulated by a solid-state imaging apparatus in a first light receiving period, which is a portion of a period in which the intensity of reflected light, from a distance measuring target, incident on the solid-state imaging apparatus rises. In addition, a photoelectron corresponding to the quantity of incident light is cumulatively accumulated by the solid-state imaging apparatus in a second light receiving period, which is a period that includes a period in which the intensity of the aforementioned reflected light incident on the solid-state imaging apparatus falls from a peak. Then, the photoelectron information cumulatively accumulated in the second light receiving period is divided by the photoelectron information cumulatively accumulated in the first light receiving period by an arithmetic unit, and the relative illumination is obtained as a value dependent on the round-trip time of the light. Thus, the distance to the distance measuring target is obtained through a time of flight (TOF) method. Furthermore, a photoelectron corresponding to the quantity of light received in a light receiving period other than the light receiving periods in which the distance is to be measured is discarded.

However, these conventional reflection sensors disclosed in the aforementioned PTLs face the following problem.

Specifically, as illustrated in FIG. 6, in a distance measuring sensor that uses a triangulation method, an output current is divided into a far-side output current and a near-side output current on the basis of the position at which light is incident on a PSD (Position Sensitive Detector: position detecting element), and the incident position is detected on the basis of a ratio between the two currents; thus, the distances to detection objects A and B can be obtained through the triangulation method.

However, in a case in which only a portion of a light projection spot illuminates a target due to the divergence of light emitted by an LED (Light Emitting Diode: light emitting diode), the centroid position of the quantity of light of the reflected light is shifted, and the distance cannot be measured with accuracy. For example, as illustrated in FIG. 6, although a detection object C is at the same distance as a detection object A, the angle of incidence of the reflected light from the detection object C onto the PSD is the same as the angle of incidence of the reflected light from a detection object B onto the PSD. Thus, the PSD output current for the detection object C is the same as the PSD output current for the detection object B, resulting in a problem of false detection.

In the aforementioned distance measuring sensor of the TOF method, the distance to the target can be obtained on the basis of the time of flight that is from when light is emitted by a light emitting unit to when the light is reflected by the target and is incident on a light receiving unit.

However, basically a target that directly faces the projection light is taken as a distance measuring target. Therefore, in a case in which the detection range is to be broadened along a plane, a mirror or the like needs to be driven in order to secure the distance—for example, scanning is carried out while changing the light projection angle with a mirror or the like, and the direction of the light projection is identified on the basis of the angle of the mirror. Alternatively, a plurality of light receiving elements may be arranged, and the direction of the target can be identified on the basis of the position of the light receiving element that has received the incident light. In this case, however, the size of the light receiving unit increases, leading to a higher cost.

In the conventional “radiation measuring method and apparatus” disclosed in the aforementioned PTL 1, a plurality of detection angle regions are necessary. In addition, in each of the “optical distance measuring apparatus” disclosed in PTL 2, the “laser distance measuring apparatus” disclosed in PTL 3, and the “contactless two-dimensional shape measuring sensor” disclosed in PTL 4, a reflective mirror for deflection and scanning is provided, and the reflected light can be detected two-dimensionally, as in the aforementioned PTL 1. However, the structure is that much more complicated.

In the “distance measuring system” disclosed in the aforementioned PTL 5, the relative illumination is used to calculate the distance to the distance measuring target through the TOF method. Furthermore, a photoelectron corresponding to the quantity of light received in a light receiving period other than the light receiving periods in which the distance is to be measured is discarded. However, a distance measuring target that directly faces the irradiation apparatus is taken as a distance measuring target, and the configuration does not allow the distance to a distance measuring target in a broad range to be calculated. Therefore, when the distance measuring range is to be broadened along a plane, scanning is carried out while changing the irradiation angle with a mirror or the like. Alternatively, it is necessary to arrange a plurality of solid-state imaging apparatuses as described above.

### CITATION LIST

### Patent Literature

PTL 1: Japanese Unexamined Patent Application Publication No. 2013-113610
PTL 2: Japanese Unexamined Patent Application Publication No. 2013-210315
PTL 3: Japanese Unexamined Patent Application Publication No. 2012-63173
PTL 4: Japanese Unexamined Patent Application Publication No. 2-61510
PTL 5: Japanese Unexamined Patent Application Publication No. 2013-134173

### SUMMARY OF INVENTION

### Technical Problem

A problem addressed by the present invention is to provide a reflection sensor having a small and simple configuration and capable of detecting, in a broad range, the presence of an object or the distance to an object in a two-dimensional plane.

### Solution to Problem

In order to solve the aforementioned problem, an optical reflection sensor of the present invention includes

a light emitting element that irradiates a distance measuring target with light,

a light receiving optical system that condenses reflected light from the distance measuring target,

a light receiving element that receives light condensed by the light receiving optical system and outputs a photoelectric current signal corresponding to a light receiving position, and

a signal processing circuit that obtains light receiving position information on the light receiving element and time-of-flight information of the light, which is a duration from when the light is emitted by the light emitting element to when the light is reflected by the distance measuring target and received by the light receiving element, on the basis of the photoelectric current signal output from the light receiving element.

In the optical reflection sensor of one embodiment,

the light emitted by the light emitting element is pulsed light,

the light receiving element is a position detecting element, the photoelectric current signal is composed of a first photoelectric current signal that is output from an electrode provided at one side of the light receiving position and a second photoelectric current signal that is output from an electrode provided at another side,

a control unit that outputs a pulsed driving signal to the light emitting element and outputs a synchronization signal that is in synchronization with a fall of the driving signal to the signal processing circuit is provided, and

the signal processing circuit is configured to

obtain the light receiving position information on the basis of a ratio between an integrated value of the first photoelectric current signal and an integrated value of the second photoelectric current signal output from the light receiving element,

divide the first photoelectric current signal and the second photoelectric current signal into two at a point at which the synchronization signal is received from the control unit, and obtain the time-of-flight information of the light on the basis of a ratio between an added value of the integrated value of each of the first photoelectric current signal and the second photoelectric current signal that precede a dividing position along a time axis and an added value of the integrated value of each of the first photoelectric current signal and the second photoelectric current signal that follow the dividing position along the time axis.

In the optical reflection sensor of one embodiment,

the light emitting element is configured to emit light having a radiation angle,

the distance measuring target is located within the radiation angle of the light emitting element, and

a storage unit that stores an arithmetic expression for calculating positional information of the distance measuring target with the light receiving optical system serving as a base point on the basis of an angle of incidence of the reflected light from the distance measuring target onto the light receiving element and the time-of-flight information of the light for the distance measuring target and

an arithmetic processing unit that obtains the angle of incidence of the reflected light from the distance measuring target on the basis of the light receiving position information obtained by the signal processing circuit and calculates the positional information of the distance measuring target by using the arithmetic expression stored in the storage unit on the basis of the obtained angle of incidence and the time-of-flight information of the light obtained by the signal processing circuit are provided.

In the optical reflection sensor of one embodiment,

the distance measuring target is located in a plurality within the radiation angle of the light emitting element,

a control unit that outputs a pulsed driving signal to the light emitting element is provided,

the signal processing circuit is configured to obtain the light receiving position information and the time-of-flight information of the light for a nearest distance measuring target that is closest to the light receiving optical system among the plurality of distance measuring targets on the basis of the driving signal and the photoelectric current signal at a point at which the photoelectric current signal rises in a case in which the length of the photoelectric current signal along the time axis is greater than the length of the driving signal along the time axis and obtain the light receiving position information and the time-of-flight information of the light for a farthest distance measuring target that is farthest from the light receiving optical system on the basis of the driving signal and the photoelectric current signal at a point at which the photoelectric current signal falls, and

the arithmetic processing unit is configured to obtain the angle of incidence of the reflected light for the nearest distance measuring target and the farthest distance measuring target on the basis of each of the light receiving position information obtained by the signal processing circuit and calculate the positional information with the light receiving optical system serving as a base point on the basis of the obtained angle of incidence and the time-of-flight information of the light obtained by the signal processing circuit.

An electronic apparatus of the present invention includes

the optical reflection sensor of the present invention.

### Advantageous Effects of Invention

As is clear from the above, the optical reflection sensor of the present invention is configured to obtain, with the signal processing circuit, the light receiving position information on the light receiving element for obtaining an angle of incidence onto the light receiving element and the time-of-flight information of the light on the basis of the photoelectric current signal output from the light receiving element. Accordingly, it is possible to compensate for shortcomings of the distance measuring method that is based on the triangulation method and the TOF method and to thus increase the accuracy in detecting the distance to the distance measuring target. Furthermore, false detection that could arise when only one of the angle of incidence and the time of flight of the light is used can be prevented.

Furthermore, the configuration of the optical system in the optical reflection sensor of the present invention includes the one and only light emitting element capable of emitting light in a broad range, the light receiving optical system, and the one and only light receiving element. Thus, it is not necessary to provide a mirror or the like for scanning while changing the irradiation angle, or the light emitting element or the light receiving element does not need to be arranged in a plurality. Accordingly, a broad-range detection along a two-dimensional plane becomes possible with a small and simple configuration.

In addition, the electronic apparatus of the present invention includes an inexpensive reflection sensor that has a small and simple configuration and that allows the presence of an object or the distance to an object in a two-dimensional plane to be detected in a broad range. Thus, when used in an electronic apparatus, such as one for the sanitary use, a vacuuming robot, and an apparatus that needs to detect a human body, an electronic apparatus that is people-friendly, environmentally friendly, and comfortable can be provided.

### BRIEF DESCRIPTION OF DRAWINGS

FIG. 1 is a schematic diagram illustrating a configuration of an optical reflection sensor of the present invention.

FIG. 2 illustrates a change in a driving signal to a light emitting element and a detection signal of a light receiving element.

FIG. 3 illustrates a state in which a distance measuring target is located between a light emitting lens and a light receiving lens.

FIG. 4 illustrates a positional relationship between an optical system and two targets present within a radiation angle.

FIG. 5 illustrates a driving signal to a light emitting element and a detection signal of a light receiving element in FIG. 4.

FIG. 6 is an illustration on how to obtain the distance to a detection object with the use of a triangulation method.

### DESCRIPTION OF EMBODIMENTS

Hereinafter, the present invention will be described in detail through the illustrated embodiments.

### First Embodiment

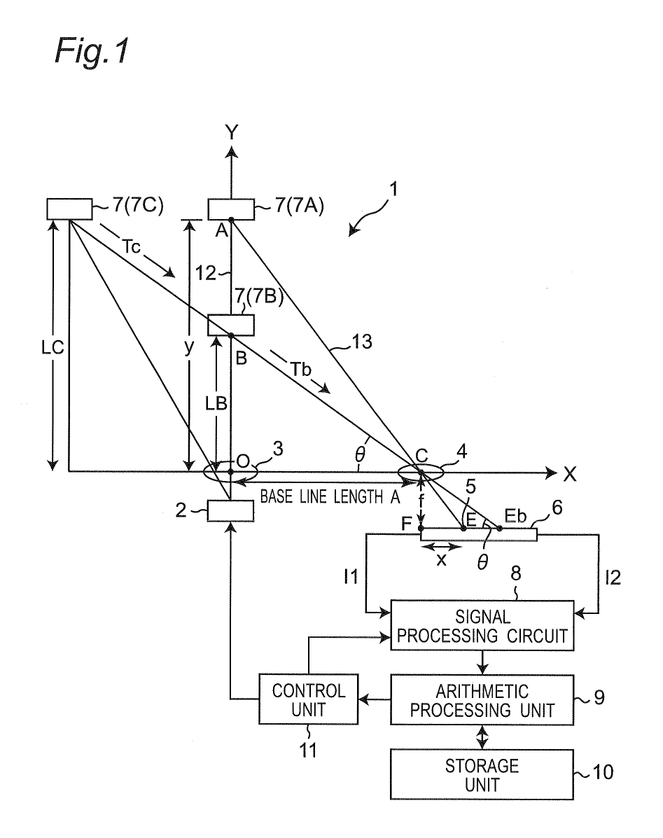

FIG. 1 is a schematic diagram illustrating a configuration of an optical reflection sensor of the present embodiment. The optical reflection sensor of the present embodiment has a configuration that incorporates both the triangulation method and the TOF method. In FIG. 1, an optical reflection sensor 1 includes a light emitting element 2, which is constituted by the aforementioned LED, that irradiates with light a distance measuring target (hereinafter, simply referred to as a target) 7, the distance to which is to be measured, a light emitting lens 3 that condenses the light emitted by the light emitting element 2, a light receiving lens 4 that condenses reflected light from the target 7, and a light receiving element 6 that images the light condensed by the light receiving lens 4 so as to form a light spot 5. Here, the light emitting element 2 may be a different element, such as an infrared light emitting element or a laser diode.

The position of the light emitting lens 3 is set as an origin O, the position on the target 7 (7A) that is to be irradiated with the light from the light emitting element 2 is set as A, the position of the light receiving lens 4 is set as a point C, and the light receiving element 6 is disposed on a straight line parallel to the X-axis, which is on the base line of the origin O. Hereinafter, for convenience of description, when a plurality of targets 7 need to be depicted in a single drawing, alphabets are appended to the respective member numbers 7 so as to distinguish thereamong.

The PSD is used in the light receiving element 6, and the light receiving element 6 detects the optical centroid position of the light spot 5 formed on the irradiated light receiving element 6 and outputs a detection signal.

A signal processing circuit 8 obtains the position of the light spot 5 on the light receiving element 6 and also obtains the time of flight of the light (hereinafter, simply referred to as the time of flight), which is the duration from when the light is emitted by the light emitting element 2 to when the light spot 5 is formed on the light receiving element 6. An arithmetic processing unit 9 calculates the angle of incidence of the reflected light from the target 7 onto the light receiving element 6 or the distance to the target 7 from the base line, which is a straight line that passes through the light emitting lens 3 and the light receiving lens 4, on the basis of the position of the light spot 5 obtained by the signal processing circuit 8. A storage unit 10 stores a time-of-flight search table, which will be described later in detail. A control unit 11 controls the operation of the light emitting element 2, the signal processing circuit 8, and so on, in response to a calculation result from the arithmetic processing unit 9.

In the configuration illustrated in FIG. 1, a light beam emitted by the light emitting element 2 toward the target 7 (7A) is condensed into a substantially parallel light beam 12 by the light emitting lens 3. This condensed parallel light beam 12 travels along the Y-axis, spotlights the point A on the target 7, and is diffusely reflected by the target 7. A light beam 13 that has been diffusely reflected by the target 7 is condensed by the light receiving lens 4. The condensed light is imaged at a point E on the light receiving element 6 to thus form the light spot 5.

Then, when a point at which a line parallel to the Y-axis that passes through the aforementioned point C (the center of the light receiving lens 4) intersects with the light receiving element 6 is set as a point F, the triangle OAC and the triangle FCE are similar.

Thus, in the measurement of the distance through the conventional triangulation method, the position of the light spot 5 is obtained with the signal processing circuit 8 on the basis of the detection signal from the light receiving element 6, and the length of the side FE (the distance x) is measured. Then, with the use of the distance x, the distance y from the light emitting lens 3 to the distance measuring target 7 is detected with the arithmetic processing unit 9 through the distance y=the distance A×(the distance f/the distance x).

Here, the aforementioned distance A is the distance between the light emitting lens 3 and the light receiving lens 4 (the base line length). In addition, the distance f is the distance between the light receiving lens 4 and the light receiving element 6 and is the focal length of the light receiving lens 4. Furthermore, the distance x is an amount of change in the optical centroid position of the light spot 5 on the light receiving element (PSD) 6 from the reference position. Here, the distance x is the aforementioned detection signal output from electrodes provided at respective ends of the light receiving element 6 and is obtained by detecting, with the signal processing circuit 8 connected to the light receiving element 6, the balance between signal currents I1 and I2 that change in accordance with the amount of change.

When the light emitted by the light emitting element 2 is made more divergent in order to allow the presence of an object or the distance to an object in a two-dimensional plane to be detected in a broad range, a problem does not arise if the size of the object is large enough to cover the entire divergence of the light. However, in FIG. 1, when there is a target 7C that is at the same distance from the base line as the target 7A but is different from the target 7A is present, the angle of incidence of the reflected light from the target 7C onto the light receiving element 6 becomes the same as the angle of incidence of the reflected light from a target 7B present on the Y-axis; thus, the distance x obtained by the signal processing circuit 8 becomes the same for the target 7C and for the target 7B. Thus, the distance LC from the base line to the target 7C is calculated as the distance y (LB) to the target 7B, resulting in false detection.

Therefore, in the present embodiment, the light receiving element 6 and the signal processing circuit 8 are equipped with a function of detecting the distance through the TOF method, and thus the above-described false detection resulting from the triangulation method is prevented.

First, with respect to a plurality of targets 7 that are assumed to be located within the radiation angle of the light emitted in a broad range by the light emitting element 2, the time of flight T, which is the duration from when the light is emitted by the light emitting element 2 to when the light is reflected by the respective targets 7 and received by the light receiving element 6, is obtained in advance. Then, for each of the targets 7, a time-of-flight search table in which the time of flight T is associated with the distance y from the base line to the target 7 and the angle of incidence θ onto the light receiving element 6 is created and stored into the storage unit 10.

When the distance is actually measured, first, a driving signal for causing pulsed light to be emitted is output to the light emitting element 2 from the control unit 11, and the pulsed light is emitted by the light emitting element 2. At the same time, a control signal for notifying that the pulsed light is turned off is output to the signal processing circuit 8.

Then, the signal processing circuit 8 and the arithmetic processing unit 9 obtain the angle of incidence θ onto the light receiving element 6 through the triangulation method, upon receiving a detection signal from the light receiving element 6 corresponding to the pulsed light emitted by the light emitting element 2. In other words, when the position on the target 7B that is irradiated with the light from the light emitting element 2 is set as B and the position of the light spot 5 formed on the light receiving element 6 is set as Eb, the triangle OBC and the triangle FCEb are similar. Thus, the position of the light spot 5 is obtained with the signal processing circuit 8 on the basis of the detection signal from the light receiving element 6, and the length of the side FEb (the distance x) is measured. Then, Tan⁻¹(f/x) is calculated for the triangle FCEb with the arithmetic processing unit 9, and the angle of incidence θ onto the light receiving element 6 is obtained.

Next, the signal processing circuit 8 obtains the time of flight Tc, which is the duration from when the pulsed light is emitted by the light emitting element 2 to when the light spot 5 is formed on the light receiving element 6 by the reflected light from the target 7C, on the basis of the detection signal from the light receiving element 6 and the control signal from the control unit 11 notifying that the pulsed light has been turned off.

Then, the arithmetic processing unit 9 searches the time-of-flight search table stored in the storage unit 10 on the basis of the obtained angle of incidence θ and the time of flight Tc obtained by the signal processing circuit 8. Then, the distance y (=LC) from the base line to the distance measuring target 7 corresponding to the angle of incidence θ and the time of flight Tc is obtained.

Here, in a case in which the time of flight obtained by the signal processing circuit 8 is Tb, the distance y from the base line to the distance measuring target 7 is obtained as LB as a result of the arithmetic processing unit 9 searching the time-of-flight search table. In other words, the different targets 7 whose angles of incidence onto the light receiving element 6 are the same angle of incidence θ can be distinguished therebetween on the basis of the difference in the time of flight.

As described thus far, according to the present embodiment, by using the PSD as the light receiving element 6, the spot position on the light receiving element 6 can be detected on the basis of a ratio between the detection signals output from the respective ends of the light receiving element 6 in accordance with the spot position on the light receiving element 6 formed by the reflected light from the target 7. Thus, the angle of incidence θ of the reflected light from the target 7 can be obtained through the triangulation method on the basis of the spot position.

In addition, the duration from when the pulsed light is emitted by the light emitting element 2 to when the detection signal is output from the light receiving element 6 is delayed by the duration of the time of flight corresponding to the distance from the base line to the target 7. Therefore, this delay time, or in other words, the time of flight T is detected on the basis of the detection signal output from the respective ends of the light receiving element 6 in accordance with the spot position and the control signal for notifying that the pulsed light has been turned off. Then, the distance from the base line to the target 7 can be obtained on the basis of the angle of incidence θ and the time of flight T.

In this case, even when the angle of incidence θ of the reflected light from the target 7 is the same, the distance from the light emitting lens 3 to the target 7 varies depending on the distance between the target 7 and the light receiving lens 4 (i.e., the time of flight T). In addition, even when the time of flight T is the same, the distance from the light emitting lens 3 to the target 7 varies depending on the angle formed by the target 7 and the light receiving lens 4 (i.e., the angle of incidence θ). This means that the accuracy in detecting the distance from the light emitting lens 3 to the target 7 can be increased by using the angle of incidence θ of the reflected light from the target 7 and the time of flight T from when the light is emitted by the light emitting element 2 to when the light is received by the light receiving element 6 while compensating for the above-described shortcomings of each method. Furthermore, false detection that could arise when only one of the angle of incidence θ and the time of flight T is used can be prevented.

In addition, the configuration of the optical system in the optical reflection sensor merely includes the one and only light emitting element 2 and the light emitting lens 3 capable of emitting light in a broad range, the light receiving lens 4, and the one and only light receiving element 6 constituted by the PSD. Thus, it is not necessary to provide a mirror or the like for scanning while changing the irradiation angle, or the light emitting element 2 or the light receiving element 6 does not need to be arranged in a plurality. Accordingly, a broad-range detection along a two-dimensional plane becomes possible with a small and simple configuration.

In other words, according to the present embodiment, with the optical reflection sensor that projects light in a single pulse, the accuracy in detecting the positional information of the target along a two-dimensional plane can be improved, and false detection can be prevented.

In the above description, the length of the side FEb (the distance x) is measured on the basis of the detection signal from the light receiving element 6, and the angle of incidence θ onto the light receiving element 6 is obtained through Tan⁻¹(f/x) with respect to the triangle FCEb. However, the present invention is not limited thereto, and the length LB of the side OB of the triangle OBC may be obtained through the triangulation method, and the angle of incidence θ may be obtained through Tan⁻¹(LB/A) with respect to the triangle OBC.

### Second Embodiment

The present embodiment relates to a method of obtaining the position of the light spot 5 on the light receiving element 6 with the signal processing circuit 8 and a method of obtaining the time of flight T from when light is emitted by the light emitting element 2 to when the light spot 5 is detected on the light receiving element 6.

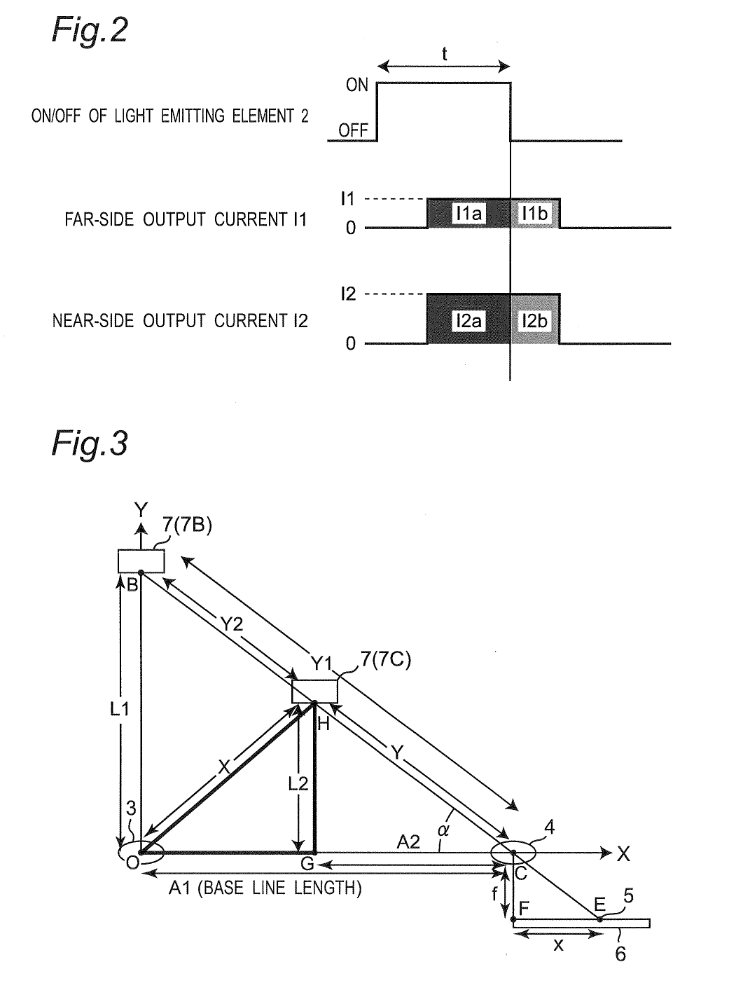

FIG. 2 illustrates, in order from the top, a timing at which the driving signal output from the control unit 11 to the light emitting element 2 is turned on/off (i.e., on/off of the light emitting element 2), a change in a far-side output current, which is a detection signal on a far side on the light receiving element 6, and a change in a near-side output current, which is a detection signal on a near side on the light receiving element 6.

Here, the far side on the light receiving element 6 is a side at which reflected light from a target 7 at a farther location forms a spot 5 on the light receiving element 6, which is a PSD. Meanwhile, the near side on the light receiving element 6 is a side at which reflected light from a target 7 at a nearer location forms a spot 5 on the light receiving element 6. Then, as illustrated in FIG. 1, the far-side output current I1 is an output current that is output from an electrode on the far-side end of the two ends of the light receiving element 6, and its value is “I1.” In a similar manner, the near-side output current I2 is an output current that is output from an electrode on the near-side end of the light receiving element 6, and its value is “I2.” It is to be noted that the far-side output current I1 is an example of the first photoelectric current signal, and the near-side output current I2 is an example of the second photoelectric current signal.

As illustrated in FIG. 2, the far-side output current I1 is divided at a timing at which the light emitting element 2 is turned off (falls). Then, an integrated value of the output current value I1 in a first light receiving period, which precedes the dividing position along the time axis, is I1a. In addition, an integrated value of the output current value I1 in a second light receiving period, which follows the dividing position along the time axis, is I1b. In a similar manner, the near-side output current I2 is divided at a timing at which the light emitting element 2 is turned off (falls). Then, an integrated value of the output current value I2 in the first light receiving period, which precedes the dividing position along the time axis, is I2a. In addition, an integrated value of the output current value I2 in the second light receiving period, which follows the dividing position along the time axis, is I2b.

Here, in a case in which the position of the target 7 moves between the far side and the near side, the far-side output current I1 and the near-side output current I2 increase and decrease in mutually opposite directions. Therefore, the position of the spot 5 on the light emitting element 2 can be obtained by comparing the integrated value (I1a+I1b) of the output current value I1 in “the first light receiving period+the second light receiving period” with the integrated value (I2a+I2b) of the output current value I2 in “the first light receiving period+the second light receiving period.”

In addition, when the time of flight T changes between long and short durations, the dividing position of the far-side output current I1 and the near-side output current I2 moves back and forth along the time axis. Therefore, the time of flight T can be obtained by comparing the added value (I1a+I2a) of the integrated values of the far-side output current I1 and the near-side output current I2 in “the first light receiving period” with the added value (I2a+I2b) of the integrated values of the far-side output current I1 and the near-side output current I2 in “the second light receiving period.”

Thus, upon receiving the far-side output current I1 and the near-side output current I2 from the light receiving element 6, which is a PSD, the signal processing circuit 8 divides the far-side output current I1 and the near-side output current I2 into the first light receiving period and the second light receiving period on the basis of the timing of a synchronization signal (a control signal that notifies that the pulsed light has been turned off) that is in synchronization with the fall of the control signal transmitted from the control unit 11 to the light emitting element 2. Then, the integrated value (I1a+I1b) of the output current value I1 and the integrated value (I2a+I2b) of the output current value I2 are calculated, and the ratio of the two integrated values “(I1a+I1b)/(I2a+I2b)” is further calculated. Then, on the basis of the value of the ratio, the position of the light spot 5 on the light receiving element 6 is obtained.

In addition, the added value (I1a+I2a) of the integrated values of the two output currents in “the first light receiving period” and the added value (I1b+I2b) of the integrated values of the two output currents in “the second light receiving period” are calculated, and the ratio of the two added values “(I1a+I2a)/(I1b+I2b)” is further calculated. Then, on the basis of the value of the ratio, the time of flight T from when the light is emitted by the light emitting element 2 to when the light spot 5 is detected on the light receiving element 6 is obtained. Here, the method of obtaining the time of flight on the basis of the value of the ratio is not particularly limited, and the time of flight T may be obtained by using a correspondence table or a correspondence expression between the value of the ratio and the time of flight created in advance, for example.

As described thus far, according to the present embodiment, with the one and only light receiving element 6, the positional information for obtaining the position of the light spot 5 on the light receiving element 6 and the time information for obtaining the time of flight T can be obtained through simple processing of dividing the far-side output current I1 and the near-side output current I2 obtained on the basis of a single instance of pulsed light emission by the light emitting element 2 at a timing at which the light emitting element 2 is turned off (falls) and carrying out arithmetic operations while changing the combinations of the obtained four integrated values I1a, I1b, I2a, and I2b of the output current values.

Accordingly, the accuracy in calculating the distance from the light emitting lens 3 to the target 7 can be improved with ease on the basis of the positional information and the time information.

### Third Embodiment

The present embodiment relates to a method of obtaining the distance from the base line to a target 7 located at a position offset from the optical axis of the light emitting element 2 in a case in which the light radiation angle of the light emitting element 2 has been broadened, without using the time-of-flight search table in the above-described first embodiment.

In the present embodiment, as illustrated in FIG. 3, a case in which the target 7C, the distance to which is to be measured, is located at an intermediate position between the light emitting lens 3 and the light receiving lens 4 is assumed.

The signal processing circuit 8 first obtains the position of the light spot 5 on the light receiving element 6 on the basis of the far-side output current I1 and the near-side output current I2 from the light receiving element 6, which is a PSD, through the processing of the above-described second embodiment, for example, and measures the length of the side FE (the distance x) of the triangle FCE. Furthermore, the distance L1 from the light emitting lens 3 to the target 7B is calculated with the arithmetic processing unit 9 through the triangulation method on the basis of a feature that the triangle OBC and the triangle FCE are similar, where a point on the imaginary target 7B present on the Y-axis that passes through the light emitting lens 3 is set as B. In this case, the distance between the light emitting lens 3 and the light receiving lens 4 is the base line length A1, the distance between the light receiving lens 4 and the light receiving element 6 is the focal length f of the light receiving lens 4, and both are known.

Then, Tan⁻¹(L1/A1) is calculated with respect to the triangle OBC, and the angle of incidence α onto the light receiving element 6 is thus obtained.

Next, the signal processing circuit 8 obtains the time of flight T from when the light is emitted by the light emitting element 2 and to when the light is reflected by the target 7C and received by the light receiving element 6 on the basis of the far-side output current I1 and the near-side output current I2 from the light receiving element 6, for example, through the processing of the above-described second embodiment.

Here, the time of flight of the light from the light receiving lens 4 to the light spot 5 on the light receiving element 6 is very short and is thus ignored. Then, it can be considered that the relationship of the following expression (1) holds among the distance X from the light emitting lens 3 to the target 7C, the distance Y from the target 7C to the light receiving element 6, and the time of flight T.

X+Y=T·C (1)

Here, C: speed of light

In addition, an intersection between a straight line parallel to the Y-axis that passes through the target 7C and the base line is set as G, and a point on the target 7C is set as a point H. Then, the length L2 between G and H and the length A2 between G and F are expressed by the following expressions (2) and (3).

L2=Y sin α (2)

A2=Y cos α (3)

Furthermore, the triangle OHG is a right triangle, and thus the relationship of the following expression (4) holds true.

X²=L2²+(A1−A2)² (4)

Thus, the arithmetic processing unit 9 calculates the distance Y from the target 7C to the light receiving element 6 through the expression (5) on the basis of the above expressions (1) through (4).

Y=(A1²−T²C²)/(2A1 cos α−2T·C) (5)

Furthermore, by plugging the value of the calculated distance Y into the above expressions (2) and (3), the distance A2 from the light receiving lens 4 to the distance measuring target 7C along the base line and the distance L2 from the base line can be calculated.

In other words, in the present embodiment, in place of the above-described time-of-flight search table, the above expressions (1) through (4) are stored in the storage unit 10.

Then, the position of the light spot 5 on the light receiving element 6 is obtained with the signal processing circuit 8 on the basis of the far-side output current I1 and the near-side output current I2 from the light receiving element 6, and the angle of incidence α of the reflected light from the target 7C onto the light receiving element 6 is obtained with the arithmetic processing unit 9 with the use of the triangulation method. Furthermore, the time of flight T from when the light is emitted by the light emitting element 2 to when the light is reflected by the target 7C and received by the light receiving element 6 is obtained with the signal processing circuit 8.

Furthermore, the positional information of the target 7C with the light receiving lens 4 serving as the base point is obtained with the arithmetic processing unit 9 on the basis of the obtained angle of incidence α and the time of flight T with the use of the above-described expressions (1) through (4) stored in the storage unit 10.

Therefore, the detection accuracy in detecting the positional information of the target 7 in a two-dimensional plane can be further improved with the use of the one and only light emitting element 2 capable of emitting light in a broad range, as compared with a case in which the time-of-flight search table is used. Furthermore, it is not necessary to create and register the time-of-flight search table, and the construction of the optical reflection sensor is facilitated.

It is to be noted that, in the present embodiment, as illustrated in FIG. 3, a case in which the target 7C, the distance to which is to be measured, is located at an intermediate position between the light emitting lens 3 and the light receiving lens 4 is assumed. However, as illustrated in FIG. 1, even in a case in which the target 7C, the distance to which is to be measured, is located on the opposite side of the light receiving lens 4 relative to the light emitting lens 3, the positional information of the target 7C with the light receiving lens 4 serving as the base point can be obtained through similar configuration and processing.

### Fourth Embodiment

The present embodiment relates to a method of detecting positional information in a case in which a plurality of targets 7 are present within the light radiation angle from the light emitting element 2, with the use of the one and only light emitting element 2 capable of emitting light in a broad range.

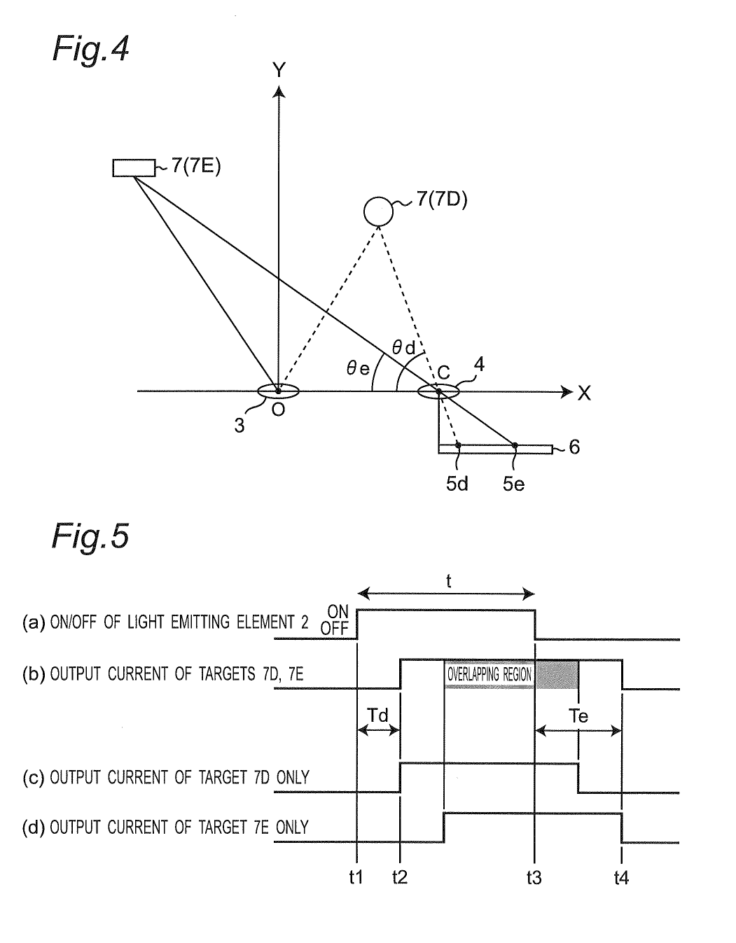

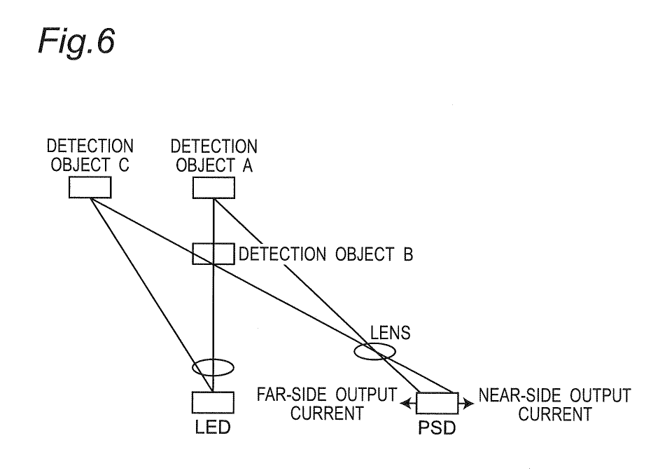

FIG. 4 illustrates the positional relationship among the light emitting lens 3, the light receiving lens 4, the light receiving element 6, and two targets 7D and 7E in the present embodiment. As illustrated in FIG. 4, one target 7D is located between the light emitting lens 3 and the light receiving lens 4, and the other target 7E is located on the opposite side of the light receiving lens 4 relative to the light emitting lens 3.

The targets 7D and 7E are both located within the light radiation angle from the light emitting element 2, and the reflected light from the target 7D is incident on the light receiving element 6 at a far-distance detection region side and forms a light spot 5d. In contrast, the reflected light from the target 7E is incident on the light receiving element 6 at a near-distance detection region side and forms a light spot 5e.

FIG. 5 illustrates the driving signal to the light emitting element 2 and the detection signal from the light receiving element 6. FIG. 5(a) illustrates the timing at which the driving signal output from the control unit 11 to the light emitting element 2 is turned on/off (i.e., on/off of the light emitting element 2). FIG. 5(b) illustrates the detection signal from the light receiving element 6 in a case in which the targets 7D and 7E are the targets of distance measurement. FIG. 5(c) illustrates the detection signal from the light receiving element 6 in a case in which only the target 7D is the target of distance measurement. FIG. 5(d) illustrates the detection signal from the light receiving element 6 in a case in which only the target 7E is the target of distance measurement. It is to, be noted that the “detection signal” may be either of the far-side output current I1 and the near-side output current I2.

The rise of the detection signal in FIG. 5(c) and in FIG. 5(d) indicates the point at which the light reflected by the target 7D or the target 7E starts being detected. In addition, the fall of the detection signal indicates the point at which the light reflected by the target 7D or the target 7E ends being detected. Therefore, the duration from a time t1 in FIG. 5(a) at which the light emitting element 2 is turned on to a point at which the detection signal falls in FIG. 5(c) and in FIG. 5(d) or the duration from a time t3 in FIG. 5(a) at which the light emitting element 2 is turned off to a point at which the detection signal falls in FIG. 5(c) and in FIG. 5(d) corresponds to the time of flight T.

Then, the time of flight T that is based on the time t1 at which the light emitting element 2 is turned on and the time of flight T that is based on the time t3 at which the light emitting element 2 is turned off are both shorter for the target 7D than for the target 7E. In other words, it is understood that the target 7D is at a position closer to the light receiving lens 4 than the target 7E.

The detection signal from the light receiving element 6 for the targets 7D and 7E illustrated in FIG. 5(b) is a detection signal in which the detection signal for the target 7D illustrated in FIG. 5(c) and the detection signal for the target 7E illustrated in FIG. 5(d) are combined. Therefore, when FIG. 5(b) is compared with FIG. 5(c) and FIG. 5(d), it is understood that a time t2 illustrated in FIG. 5(b) at which the detection signal rises corresponds to a point at which the light detection signal for the target 7D located closest to the light receiving lens 4 rises and that a time t4 illustrated in FIG. 5(b) at which the detection signal falls corresponds to a point at which the light detection signal for the target 7E located farthest from the light receiving lens 4 falls.

In other words, the duration from the time t1 in FIG. 5(a) at which the light emitting element 2 is turned on to the time t2 illustrated in FIG. 5(b) at which the detection signal rises corresponds to the time of flight Td for the nearest target 7D. In addition, the duration from the time t3 in FIG. 5(a) at which the light emitting element 2 is turned off to the time t4 illustrated in FIG. 5(b) at which the detection signal falls corresponds to the time of flight Te for the farthest target 7E.

Thus, the ratio I1d/I2d of the output currents is calculated with the signal processing circuit 8 on the basis of the far-side output current I1d and the near-side output current I2d from the light receiving element 6 on the basis of the timing of the time t2 illustrated in FIG. 5(b) at which the detection signal rises, and thus the position of the light spot 5d on the light receiving element 6 formed by the reflected light from the nearest target 7D is obtained. Furthermore, the angle of incidence θd of the reflected light from the target 7D is obtained with the arithmetic processing unit 9 on the basis of the position of the light spot 5d through the triangulation method.

Furthermore, the duration from the time t1 to the time t2 is measured with the signal processing circuit 8, and thus the time of flight Td for the target 7D is obtained.

Then, the positional information of the target 7D with the light receiving lens 4 serving as the base point can be obtained with the arithmetic processing unit 9 on the basis of the obtained angle of incidence θd of the target 7D and the time of flight Td through the processing of the above-described third embodiment.

In a similar manner, the position of the light spot 5e on the light receiving element 6 formed by the reflected light from the farthest target 7E is obtained with the signal processing circuit 8 on the basis of the timing of the time t4 illustrated in FIG. 5(b) at which the detection signal falls, and the angle of incidence θe of the reflected light from the target 7E is obtained with the arithmetic processing unit 9. Furthermore, the time of flight Te for the target 7E is obtained with the signal processing circuit 8 on the basis of the duration from the time t3 to the time t4.

Then, the positional information of the target 7E with the light receiving lens 4 serving as the base point can be obtained with the arithmetic processing unit 9 on the basis of the obtained angle of incidence θe for the target 7E and the time of flight Te.

It is to be noted that the method of obtaining the position of the light spot 5e for the farthest target 7E on the basis of the timing of the time t4 is not particularly limited. For example, upon detecting that the driving signal from the control unit 11 to the light emitting element 2 has been turned off (i.e., the light emitting element 2 has been turned off), the signal processing circuit 8 iteratively calculates the ratio I1d/I2d between the far-side output current I1d and the near-side output current I2d at a constant interval that is sufficiently shorter than the wavelength t of the driving signal and retains the calculation result. Then, the position of the light spot 5e may be obtained on the basis of, among the retained calculation results, the value of the ratio I1d/I2d of the output currents calculated at a point temporally closest to the time t4, on the basis of the timing of the time t4 at which the detection signal falls. Alternatively, the far-side output current I1d and the near-side output current I2d may be stored at the aforementioned constant interval, and the position of the light spot 5e may be obtained on the basis of the ratio I1d/I2d of the two output currents stored at a point temporally closest to the time t4.

The above description applies to a case in which two targets 7D and 7E are present within the radiation angle from the light emitting element 2. However, in a case in which three or more targets 7 are present within the radiation angle, the detection signal obtained by the light receiving element 6 is a signal in which the detection signals for the three or more targets 7 are combined. Thus, although it is possible to identify the detection signal for the target 7 closest to the light receiving lens 4 on the basis of the rise of the detection signal and to identify the detection signal for the target 7 farthest from the light receiving lens 4 on the basis of the fall of the detection signal, the detection signal for the target 7 at an intermediate position is buried in the detection signals for the aforementioned two targets 7 and thus cannot be identified.

However, the positional information of the nearest target 7 with the light receiving lens 4 serving as the base point can be obtained through the above-described processing on the basis of the time at which the detection signal obtained by the light receiving element 6 rises, and the positional information of the farthest target 7 with the light receiving lens 4 serving as the base point can be obtained on the basis of the timing at which the detection signal falls. Therefore, it can be determined that the position of the target 7 other than the targets 7 closest and farthest to and from the light receiving lens 4 falls at an intermediate position between the stated two targets 7.

As described thus far, in a case in which the positional information of a plurality of targets 7 present within the radiation angle from the light emitting element 2 is to be detected with the use of the one and only light emitting element 2 capable of emitting light in a broad range, a detection signal in which the detection signals for the plurality of targets 7 are combined is obtained by the light receiving element 6, which is a PSD.

Then, in a case in which the length of the obtained detection signal along the time axis is greater than the length of the control signal to the light emitting element 2 along the time axis, the position of the light spot 5 for the nearest target 7 is obtained with the signal processing circuit 8 on the basis of the timing of the time t2 at which the detection signal rises, and the angle of incidence θ of the nearest target 7 is obtained with the arithmetic processing unit 9 on the basis of the position of the light spot 5. Furthermore, the time of flight T for the nearest target 7 is obtained with the signal processing circuit 8 on the basis of the duration from the time t1 to the time t2.

Then, the positional information of the nearest target 7 with the light receiving lens 4 serving as the base point is obtained with the arithmetic processing unit 9 on the basis of the obtained angle of incidence θ and the time of flight T.

In a similar manner, the position of the light spot 5 for the farthest target 7, the angle of incidence θ, and the time of flight T based on the duration from the time t3 to the time t4 are obtained on the basis of the timing of the time t4 at which the obtained detection signal falls. Then, the positional information of the farthest target 7 with the light receiving lens 4 serving as the base point is obtained on the basis of the obtained angle of incidence θ and the time of flight T.

Therefore, the positional information of the plurality of targets 7 present within the light radiation angle from the light emitting element 2 can be detected simultaneously through an single instance of pulsed light emission with the use of the single light emitting element 2 capable of emitting light in a broad range and the single light receiving element 6.

In other words, it is not necessary to provide a plurality of light emitting elements 2 or a plurality of light receiving elements 6 or to provide a mirror or the like for scanning while changing the irradiation angle, in order to detect the positional information of the plurality of targets 7 simultaneously. Therefore, an inexpensive optical reflection sensor that has a small and simple configuration, has high detection accuracy, and is easy to handle can be provided.

### Fifth Embodiment

As described thus far, according to the first through fourth embodiments, an inexpensive reflection sensor having a small and simple configuration and capable of detecting, in a broad range, the presence of an object or the distance to an object in a two-dimensional plane with high accuracy can be provided. Such a reflection sensor is suitably used in an electronic apparatus such as one for the sanitary use, a vacuuming robot, and an apparatus that needs to detect a human body, and an electronic apparatus that is people-friendly, environmentally friendly, and comfortable can be provided.

In summarizing the present invention, an optical reflection sensor of the present invention includes

a light emitting element 2 that irradiates a distance measuring target 7 with light,

a light receiving optical system 4 that condenses reflected light from the distance measuring target 7,

a light receiving element 6 that receives light condensed by the light receiving optical system 4 and outputs a photoelectric current signal corresponding to a light receiving position, and

a signal processing circuit 8 that obtains light receiving position information on the light receiving element 6 and time-of-flight information of the light, which is a duration from when the light is emitted by the light emitting element 2 to when the light is reflected by the distance measuring target 7 and received by the light receiving element 6, on the basis of the photoelectric current signal output from the light receiving element 6.

In a case in which the distances to a plurality of distance measuring targets 7 are to be detected in a broad range on the basis of reflected light from the distance measuring targets 7 within a two-dimensional plane, a distance measuring method based on a triangulation method or a TOF method is used.

The distance measuring method based on the triangulation method is based on the angle of incidence of the reflected light from each of the distance measuring targets 7 onto the light receiving element 6. However, there are shortcomings in that, even when the angle of incidence is the same, the distance to the distance measuring target 7 varies depending on the time of flight of the light in which the light from the light emitting element 2 is received by the light receiving element 6.

On the other hand, the distance measuring method based on the TOF method is based on the time of flight of the light. However, there are shortcomings in that, even when the time of flight of the light is the same, the distance to the distance measuring target 7 varies depending on the angle of incidence formed by the distance measuring target 7 and the light receiving optical system 4 (i.e., the angle of incidence).

The foregoing means that, in measuring the distance to the distance measuring target 7, the combined use of the angle of incidence and the time of flight of the light makes it possible to increase the accuracy in detecting the distance to the distance measuring target 7 while compensating for the above-described shortcomings of each.

According to the above-describe configuration, the light receiving position information on the light receiving element 6 for obtaining the angle of incidence onto the light receiving element 6 and the time-of-flight information of the light are obtained with the signal processing circuit 8 on the basis of the photoelectric current signal output from the light receiving element 6. Accordingly, it is possible to compensate for shortcomings of the distance measuring method based on the triangulation method and the TOF method and to increase the accuracy in detecting the distance to the distance measuring target 7. Furthermore, false detection that could arise when only one of the angle of incidence and the time of flight of the light is used can be prevented.

In addition, the configuration of the optical system in the optical reflection sensor of the present invention includes the one and only light emitting element 2 capable of emitting light in a broad range, the light receiving optical system 4, and the one and only light receiving element 6. Thus, it is not necessary to provide a mirror or the like for scanning while changing the irradiation angle, or the light emitting element 2 or the light receiving element 6 does not need to be arranged in a plurality. Accordingly, a broad-range detection along a two-dimensional plane becomes possible with a small and simple configuration.

In the optical reflection sensor of one embodiment,

the light emitted by the light emitting element 2 is pulsed light,

the light receiving element 6 is a position detecting element, the photoelectric current signal is composed of a first photoelectric current signal I1 that is output from an electrode provided at one side of the light receiving position and a second photoelectric current signal I2 that is output from an electrode provided at another side,

a control unit 11 that outputs a pulsed driving signal to the light emitting element 2 and outputs a synchronization signal that is in synchronization with a fall of the driving signal to the signal processing circuit 8 is provided, and

the signal processing circuit 8 is configured to

obtain the light receiving position information on the basis of a ratio between an integrated value of the first photoelectric current signal I1 and an integrated value of the second photoelectric current signal I2 output from the light receiving element 6,

divide the first photoelectric current signal I1 and the second photoelectric current signal I2 into two at a point at which the synchronization signal is received from the control unit 11, and obtain the time-of-flight information of the light on the basis of a ratio between an added value (I1a+I2a) of the integrated value of each of the first photoelectric current signal and the second photoelectric current signal that precede a dividing position along a time axis and an added value (I1b+I2b) of the integrated value of each of the first photoelectric current signal and the second photoelectric current signal that follow the dividing position along the time axis.

According to this embodiment, the first photoelectric current signal I1 and the second photoelectric current signal I2 obtained on the basis of a single instance of pulsed light emission from the light emitting element 2 are divided with the single light receiving element 6 in synchronization with the fall of the driving signal to the light emitting element 2. Then, the light receiving position information and the time-of-flight information of the light are calculated while changing the combinations of the integrated values I1a, I1b, I2a, and I2b of the obtained four partial photoelectric current signals.

Therefore, the light receiving position information and the time-of-flight information of the light can be obtained through simple processing of dividing the first photoelectric current signal I1 and the second photoelectric current signal I2 from the light receiving element 6 in synchronization with the fall of the driving signal and carrying out a calculation while changing the combinations of the integrated values I1a, I1b, I2a, and I2b of the obtained four partial photoelectric current signals.

In the optical reflection sensor of one embodiment,

the light emitting element 2 is configured to emit light having a radiation angle,

the distance measuring target 7 is located within the radiation angle of the light emitting element 2, and

a storage unit 10 that stores an arithmetic expression for calculating positional information of the distance measuring target 7 with the light receiving optical system 4 serving as a base point on the basis of an angle of incidence of reflected light from the distance measuring target 7 onto the light receiving element 6 and the time-of-flight information of the light for the distance measuring target 7 and

an arithmetic processing unit 9 that obtains the angle of incidence of the reflected light from the distance measuring target 7 on the basis of the light receiving position information obtained by the signal processing circuit 8 and calculates the positional information of the distance measuring target 7 by using the arithmetic expression stored in the storage unit 10 on the basis of the obtained angle of incidence and the time-of-flight information of the light obtained by the signal processing circuit 8 are provided.

According to this embodiment, the positional information of the distance measuring target 7 is calculated with the arithmetic processing unit 9 with the use of the arithmetic expression stored in the storage unit 10 on the basis of the angle of incidence of the reflected light that is based on the light receiving position information and the time-of-flight information of the light.

Therefore, the accuracy in detecting the positional information of the distance measuring target 7 in a two-dimensional plane with the use of the one and only light emitting element 2 capable of emitting light in a broad range can be further improved.

In the optical reflection sensor of one embodiment,

the distance measuring target 7 is located in a plurality within the radiation angle of the light emitting element 2,

a control unit 11 that outputs a pulsed driving signal to the light emitting element 2 is provided,

the signal processing circuit 8 is configured to obtain the light receiving position information and the time-of-flight information of the light for a nearest distance measuring target 7D that is closest to the light receiving optical system 4 among the plurality of distance measuring targets 7 on the basis of the driving signal and the photoelectric current signal at a point at which the photoelectric current signal rises in a case in which the length of the photoelectric current signal along the time axis is greater than the length of the driving signal along the time axis and obtain the light receiving position information and the time-of-flight information of the light for a farthest distance measuring target 7E that is farthest from the light receiving optical system 4 on the basis of the driving signal and the photoelectric current signal at a point at which the photoelectric current signal falls, and

the arithmetic processing unit 9 is configured to obtain the angle of incidence of the reflected light for the nearest distance measuring target 7D and the farthest distance measuring target 7E on the basis of each of the light receiving position information obtained by the signal processing circuit 8 and calculate the positional information with the light receiving optical system 4 serving as a base point on the basis of the obtained angle of incidence and the time-of-flight information of the light obtained by the signal processing circuit 8.

According to this embodiment, with the signal processing circuit 8, the light receiving position information and the time-of-flight information of the light for the nearest distance measuring target 7D that is closest to the light receiving optical system 4 and the farthest distance measuring target 7E that is farthest from the light receiving optical system 4 are obtained on the basis of the driving signal and the photoelectric current signal at points at which the photoelectric current signal rises and falls.

Therefore, the positional information of the plurality of distance measuring targets 7 present within the light radiation angle from the light emitting element 2 can be detected simultaneously through an single instance of pulsed light emission with the use of the single light emitting element 2 capable of emitting light in a broad range and the single light receiving element 6.

In other words, it is not necessary to provide a plurality of light emitting elements 2 or a plurality of light receiving elements 6 or to provide a mirror or the like for scanning while changing the irradiation angle, in order to detect the positional information of the plurality of distance measuring targets 7 simultaneously. Therefore, an inexpensive optical reflection sensor that has a small and simple configuration, has high detection accuracy, and is easy to handle can be provided.

An electronic apparatus of the present invention includes

the optical reflection sensor of the present invention.

According to the above-described configuration, an inexpensive reflection sensor that allows the presence of an object or the distance to an object in a two-dimensional plane to be detected in a broad range with high accuracy with a small and simple configuration is used. Thus, when used in an electronic apparatus, such as one for the sanitary use, a vacuuming robot, and an apparatus that needs to detect a human body, an electronic apparatus that is people-friendly, environmentally friendly, and comfortable can be provided.

### REFERENCE SIGNS LIST

1 OPTICAL REFLECTION SENSOR
2 LIGHT EMITTING ELEMENT
3 LIGHT EMITTING LENS
4 LIGHT RECEIVING LENS
5 LIGHT SPOT
6 LIGHT RECEIVING ELEMENT
7 TARGET
8 SIGNAL PROCESSING CIRCUIT
9 ARITHMETIC PROCESSING UNIT
10 STORAGE UNIT
11 CONTROL UNIT
12 PARALLEL LIGHT BEAM
13 DIFFUSELY REFLECTED LIGHT BEAM

1-5. (canceled)

6. An optical reflection sensor, comprising:
a light emitting element that irradiates a distance measuring target with light;
a light emitting lens that condenses the light emitted by the light emitting element;
a light receiving optical system that condenses reflected light from the distance measuring target;
a light receiving element that receives light condensed by the light receiving optical system and outputs a photoelectric current signal corresponding to a light receiving position; and
a signal processing circuit that obtains light receiving position information on the light receiving element and time-of-flight information of the light, which is a duration from when the light is emitted by the light emitting element to when the light is reflected by the distance measuring target and received by the light receiving element, on the basis of the photoelectric current signal output from the light receiving element,
wherein the light emitting element is configured to emit light having a radiation angle,
wherein the distance measuring target is located within the radiation angle of the light emitting element,
wherein the optical reflection sensor further comprises:
a storage unit that stores the following arithmetic expressions through for calculating positional information of the distance measuring target with the light receiving optical system serving as a base point on the basis of an angle of incidence of the reflected light from the distance measuring target onto the light receiving element and the time-of-flight information of the light for the distance measuring target,
X+Y=T·C [1]
L2=Y sin α [2]
A2=Y cos α [3]
X²=L2²+² [4]
where
X: distance from the light emitting lens to the distance measuring target
Y: distance from the distance measuring target to the light receiving element
T: time-of-flight information of the light
C: speed of light
L2: distance from a base line, which is a straight line passing through the light emitting lens and the light receiving lens, to the distance measuring target
α: angle of incidence of the reflected light from the distance measuring target onto the light receiving element
A2: distance from an intersection between a perpendicular line extending from the distance measuring target to the base line and the base line to the light receiving lens; and
an arithmetic processing unit that obtains the angle of incidence of the reflected light from the distance measuring target on the basis of the light receiving position information obtained by the signal processing circuit and calculates the positional information of the distance measuring target by using the arithmetic expressions stored in the storage unit on the basis of the obtained angle of incidence and the time-of-flight information of the light obtained by the signal processing circuit.

7. The optical reflection sensor according to claim 6,
wherein the light emitted by the light emitting element is pulsed light,
wherein the light receiving element is a position detecting element, the photoelectric current signal is composed of a first photoelectric current signal that is output from an electrode provided at one side of the light receiving position and a second photoelectric current signal that is output from an electrode provided at another side,
wherein a control unit that outputs a pulsed driving signal to the light emitting element and outputs a synchronization signal that is in synchronization with a fall of the driving signal to the signal processing circuit is provided, and
wherein the signal processing circuit is configured to
obtain the light receiving position information on the basis of a ratio between an integrated value of the first photoelectric current signal and an integrated value of the second photoelectric current signal output from the light receiving element,
divide the first photoelectric current signal and the second photoelectric current signal into two at a point at which the synchronization signal is received from the control unit, and obtain the time-of-flight information of the light on the basis of a ratio between an added value of the integrated value of each of the first photoelectric current signal and the second photoelectric current signal that precede a dividing position along a time axis and an added value of the integrated value of each of the first photoelectric current signal and the second photoelectric current signal that follow the dividing position along the time axis.

8. An electronic apparatus comprising the optical reflection sensor according to claim 6.

9. An electronic apparatus comprising the optical reflection sensor according to claim 7.
